(19) United States
(12) Patent Application Publication
(10) Pub. No.: US 2009/0043641 A1
(43) Pub. Date: Feb. 12, 2009

(54) PRETRIAL RELEASE SYSTEM AND METHOD

(76) Inventors: Russell S. Henry, Macon, MO (US); Bob J. Mantlo, Columbia, MO (US); David Waite, Kansas City, MO (US)

Correspondence Address: HUSCH BLACKWELL SANDERS LLP, 4801 Main Street, Suite 1000, KANSAS CITY, MO, 64112, US

(21) Appl. No.: 12/188,423

(22) Filed: Aug. 8, 2008

Related U.S. Application Data
(60) Provisional application No. 60/955,088, filed on Aug. 10, 2007.

(51) Int. Cl. G06Q 10/00

(52) U.S. Cl. 705/10; 705/1

(57) ABSTRACT

The present invention describes a system and method whereby enhancements are made to an agency pretrial information system by a consortium of service and equipment providers and such enhancements are self funded by means of a electronic custodial fee so as to allow the addition of desired and/or recommended components without necessitating a considerable, or in some instances, any capital investment on the part of the agency.

### CROSS-REFERENCE TO RELATED APPLICATIONS

This application claims priority to U.S. Provisional Application No. 60/855,088 filed Aug. 10, 2007, the disclosure of which is incorporated herein in its entirety.

### BACKGROUND OF THE INVENTION

Law enforcement, due to the very nature of the profession, is in the unique position of identifying, disrupting, and “stumbling on” individuals who may be wanted by other state and federal agencies for other criminal activity or terrorist plots. Being in the front line requires law enforcement, particularly at the state, county, and local level, to have all technological tools readily available to them.

Acquiring such technical tools, however, can be very expensive. For example, the initial cost associated with obtaining a biometric identification system is often so high as to be prohibitive for the law enforcement agencies that would benefit most by utilizing such a system. In many cases when a law enforcement agency can afford to buy such systems, the agency may struggle to find the funding that is necessary to cover the annual costs associated with such a system, such as electronic communications, maintenance, upgrades, and updates.

Integrated justice information systems, computer-based systems that enable instantaneous exchange of information about persons and events across the boundaries of different agencies and institutions, are now operational in a few jurisdictions and are being developed in many others. Pretrial service systems used to support pretrial services represent an area where integration of agency resources can be useful to all those involved. While a primary function of most pretrial service programs is the collection of information that is mainly used in the pretrial release/detention decision-making process and to monitor compliance with conditions of release. However, this information often can be valuable to other justice system agencies. By sharing information while maintaining appropriate safeguards, the agencies that utilize a pretrial services system can significantly contribute to the administration of justice in ways that extend beyond their core functions.

Government agencies are subject to an ever-present pressure to reduce costs. Agencies forced to deal with tight budgetary restrictions, possible changing budgetary priorities, and evaporation of grant funds. As a result, many law enforcement agencies are hard pressed to make badly needed purchases to obtain equipment and services. Since many federal and state funding opportunities are one-time grants, an enormous fiscal void is often left for local agencies to overcome.

To compound matters, technology is changing at a rapid pace. Moore's Law states that technological capabilities and processing speed doubles every 24 months. What this means to criminal justice agencies, and law enforcement in particular, is that agency systems and tools currently in use will likely need to be replaced either in whole or part every five years. While states, counties, and municipalities have funded key infrastructure and application projects within one time federal grants, it has typically fallen on the individual lead agencies to absorb the cost of maintaining and supporting these initiatives. Furthermore, a predictable funding stream to support recurring costs has not been established. State, county, and municipal agencies do not have the ability to fund these projects either in whole or supplementary due to decreasing existing budgets.

While it is important for biometric and other identification technologies to be implemented at all levels of law enforcement, it is just as important for agencies to have the ability to share such information across State, County, and municipal jurisdictional agency boundaries. It will be appreciated by one of skill in the art, that information about an individual that does not affect one agency, may be decidedly vital to another. Of those law enforcement agencies that do have such biometric identification systems, many of the systems are stand alone or not integrated with other agency systems for records management, jail management, the office of the prosecutor, the courts, office of probation, or centralized systems such as a state fingerprint repository.

### SUMMARY OF THE INVENTION

The foregoing needs are met, to a great extent, by the present invention, wherein in one aspect a method is provided whereby enhancements are made to an agency pretrial information system by a consortium of service and equipment providers and such enhancements are self funded by means of a electronic custodial fee so as to allow the addition of desired and/or recommended components without necessitating a considerable, or in some instances, any capital investment on the part of the agency.

There is also provided in the practice of the invention, a method is provided for enhancing the operation of law enforcement agency systems via self-funding, where the method includes the steps of providing an agency with one or more components desired by the agency, collecting an electronic custodial fee (“ECF”) from an individual incarcerated by the agency, and distributing at least a portion of the ECF to one or more vendors for providing the one or more components to the agency. According to embodiments of the present invention, components comprise services, equipment, or a combination of both.

Also provided in accordance with the inventive method and system is a method of enhancing the operation agency systems via an electronic custodial fee (“ECF”), where the method includes the steps of calculating an anticipated ECF income based on historical incarceration volumes for the agency, establishing a minimum ECF income level required for components desired by the agency, providing the agency with one or more components desired by the agency, collecting the ECF from an individual incarcerated by the agency prior to release of the individual, distributing at least a portion of the ECF to vendors for providing components desired by the agency, and periodically invoicing the agency to make up for any difference between the minimum ECF income level and collected ECF income level. According to some embodiments of the present invention, the historical incarceration volumes for the agency may include statewide, regional, or nationwide metrics.

In accordance with the present inventive system and method existing agency systems are analyzed and a determination is made as to what enhancements are desired by the agency. Following an evaluation of the composition of the agency program presently in place, a series of recommendations may be provided to the agency and compared to a list of the agencies desired enhancements.

The techniques used by well-functioning pretrial services programs including information gathering, risk assessment, and supervision of released defendants by applying a broad array of methods. These methods have been developed to help make pretrial decision-making more fair and equitable and to provide a greater measure of public safety. The heart of pretrial services program operations is the collection, verification, and analysis of information about defendants and available supervisory options.

In accordance with one embodiment of the present invention, the system is implemented at a metropolitan scale, however, it will be appreciated by one of skill in the art that system of the present invention may also be implemented at on the county sheriff department level within a state. Further embodiments of the present invention may also be implemented with municipal law enforcement agencies. The present invention ensures a continual stream of funding that will allow the provision of the appropriate components including equipment, software, and services to fully participate in initiatives on a real-time basis.

A system in accordance with the present invention includes components that are administratively based in jail as this provides first detailed informational gathering with offender is during booking (intake process) in most cases (front end information gathering). According to the FBI's Bureau of Justice Statistics, information gathered at booking and passed to other criminal justice agencies is correct 97% of the time. By including components of the inventive system at the intake level, duplication of effort is reduced where the staff does not have to repeat entry of offender information at each agency. The reduction of redundant data input provides increased accuracy and increases the timeliness of information retrieval. According to the Bureau of Justice Statistics, by having to input offender data just a second time drops accuracy to 72%.

An embodiment in accordance with the information collection methodology of the present invention and system provide for ample revenue and allow for a complete technological systems replacement every five years or as needed. The system of the present invention utilizes certified systems that meet all the state and federal requirements and standards while maintaining the ability and flexibility to grow as required to future legislative or event actions or occurrences.

According to some embodiments of the present invention, the consortium includes a group of professional companies that are capable of coordinating deep specialist expertise to work in a concerted manner. Such coordination of consortium member companies allows for the integration and application of different services and equipment provided by each company participating in the enhancement of a particular client agency. The consortium approach of the present inventive method and system provides a client agency with advantages and familiarity of a single provider, while allowing for selection of the best value provider for each class of work.

The present invention provides enhancements to an agency's existing tools via the addition of component equipment, services, or some combination thereof. in the form of equipment and/or service components to an existing pretrial release support system and a self-funding mechanism for such enhancements that is in compliance with current state and federal laws. While not requiring any additional protocols from arresting/releasing commission and civilian personnel.

The self-funding aspect of the present inventive system and method provides desired enhancements without adding pressure to already strained budgets thus, allowing all agencies located within the participating criminal justice system to focus resources on other necessary and urgent tasks and priorities. According to some embodiments of the present inventive method and system, recommendations for enhancing agency systems include those from participatory bureaus and associations such as United States Department of Justice—Office of Justice Programs—Bureau of Justice Statistics for Pretrial Release and Detention (BJS).

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

In the accompanying drawings, which form a part of the specification and are to be read in conjunction therewith in which like reference numerals are used to indicate like or similar parts in the various views:

Further features of the present invention will become apparent to those skilled in the art to which the present invention relates from reading the following description with reference to the accompanying drawings, in which:

FIG. 1 illustrates a law enforcement agency environment in which an embodiment of the present inventive method and system may operate.

FIG. 2 is a block diagram of an embodiment of the method in accordance with an embodiment of the present invention.

FIG. 3 is a block diagram of an embodiment of the method in accordance with another embodiment of the present invention.

### DETAILED DESCRIPTION OF THE INVENTION

The invention will now be described with reference to the drawing figures, in which like reference numerals refer to like parts throughout. An embodiment in accordance with the present inventive system and method allows for the enhancement of the operation of agency systems via an electronic custodial fee (“ECF”). The present invention describes a system and method whereby enhancements are made to an agency pretrial information system by a consortium of service and equipment providers and such enhancements are self funded by means of a electronic custodial fee so as to allow the addition of desired and/or recommended components without necessitating a considerable, or in some instances, any capital investment on the part of the agency. The above description is of an embodiment of the present invention and as such, is not intended to suggest any limitation in the scope of using or functionality of the invention.

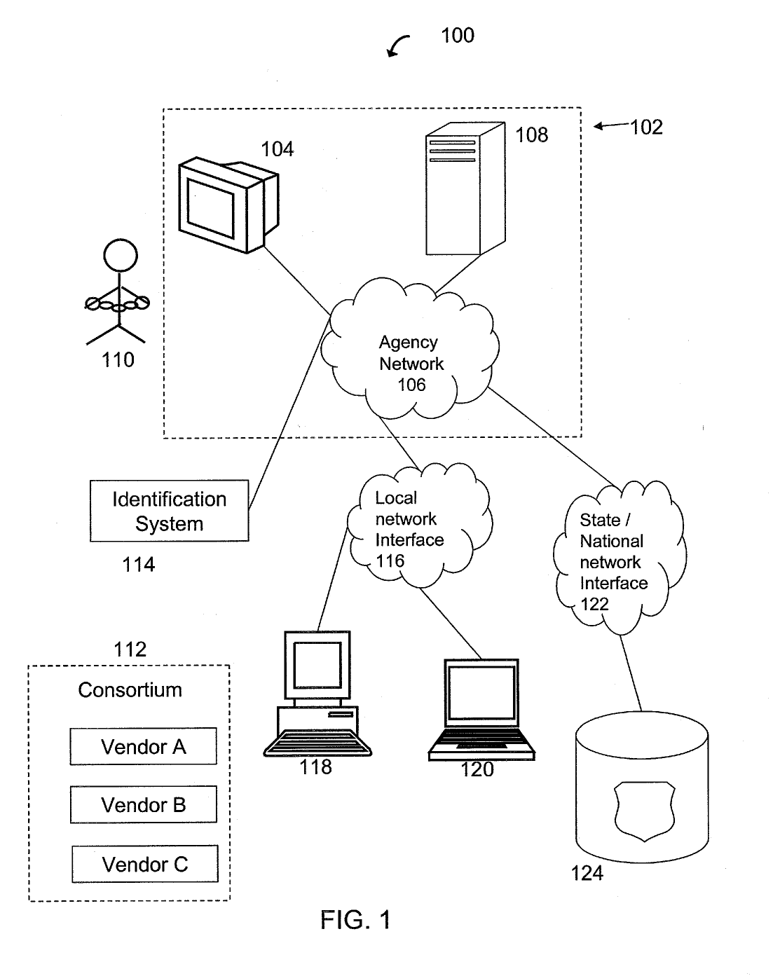

Turning to FIG. 1, shown is a law enforcement agency environment 100 in which an embodiment of the present inventive method and system may operate. As shown within a dashed rectangle, existing agency system 102 components include a terminal 104, an agency network 106 and a record storage system 108. In operation, an incarcerated individual 110 is processed by the agency using the terminal 104. Information about the incarcerated individual 110 is saved to record storage 108 via the agency network 106. Typically, an individual is brought into an agency policy station or jail upon arrest. Upon arrival, the individual is booked, photographed, and fingerprinted. Often a bond amount is set for the individual, typically off of a bond schedule sheet. Individuals charged with serious offenses may end up in front of a judge before a bond amount is set.

A consortium 112 of professional companies is shown and includes vendor 112A, vendor 112B, and vendor 112C. It will be appreciated by one of skill in the art that the companies may include equipment providers, professional service providers, and member companies that perform both functions. In accordance with a method of the present invention, desired components are added to the existing agency system 102 by consortium member companies 112.

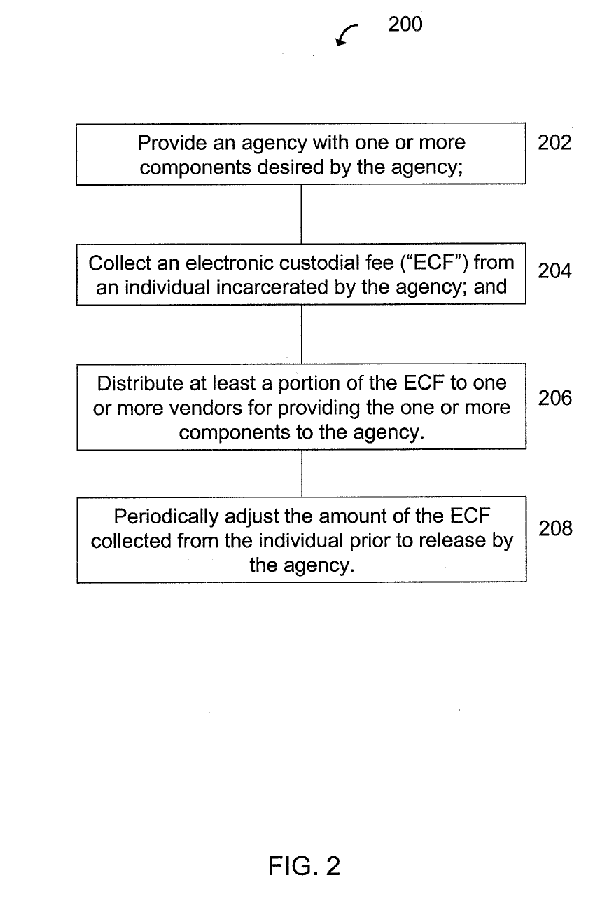

Turning to FIG. 2 shown is a block diagram of an embodiment of the method 200 in accordance with an embodiment of the present invention. In block 202, an agency is provided with one or more components desired by the agency by one or more members of a consortium 112 of professional companies. It will be appreciated by one of skill in the art that the companies may include equipment providers, system integrators, information technology processing and storage, other service providers, and member companies that perform more than one function.

In block 204, an electronic custodial fee (“ECF”) is collected from an individual incarcerated by the agency 110. In accordance with an embodiment of the present invention, the individual is charged a small fee called an “Electronic Custodial Fee” or “ECF” prior to release. One of skill in the art will appreciate that the ECF may be collected from the individual at a number of locations via any conventional payment methods. For example, the ECF may be charged at the police station, jail, or by the courthouse treasurer. It will also be appreciated that according to some embodiments of the present inventive method and system the ECF may be collected at different points in the incarceration procedure, including prior to release of the individual or upon the individuals return to court.

In block 206, at least a portion of the ECF is distributed to one or more vendors for providing the one or more components to the agency. According to one embodiment of the present inventive method, ECF proceeds are collected and at least a portion of the ECF proceeds are paid to vendors/companies providing services and/or equipment to the agency. In block 208, the amount of the ECF collected from the individual prior to release by the agency is periodically adjusted. Periodic adjustment may be accomplished in any number of ways, including by mutual agreement of the agency and consortium companies.

Turning back to FIG. 1, an identification system 114 is added to the existing agency system 102 via the agency network 106. According to an embodiment of the present invention and method, biometric technology is added to existing agency systems to offer information based on “identification” of an individual instead of relying exclusively on verification methods. Some embodiments of the present invention and system provide components including FBI/State certified “live scan” system(s), “regional” AFIS/APIS systems/services/training programs (providing “lights-out” criminal fingerprint submission and processing), offender identification ability, and interoperable communications with 256-bit AES encryption (appliance and software).

As also illustrated, additional desired components are added by consortium member companies including a local network interface 116 which extends the existing agency network 106 to other local agencies including the court system 118 and the prosecutor system 120. Additionally, a statewide and/or national network interface 122 is added to existing agency network 106. Access to statewide, FBI, or other national agency information repository 124 is possible through secure channels of network interface 122. One of skill in the art will appreciate that secure protocols and connections will likely be provided by one or more consortium vendors with system integration expertise. Additionally, it should be noted that data interface protocols between agency systems and other systems, such as statewide or national systems, may be accomplished using any number of appropriate data formats including extensible markup language, for example.

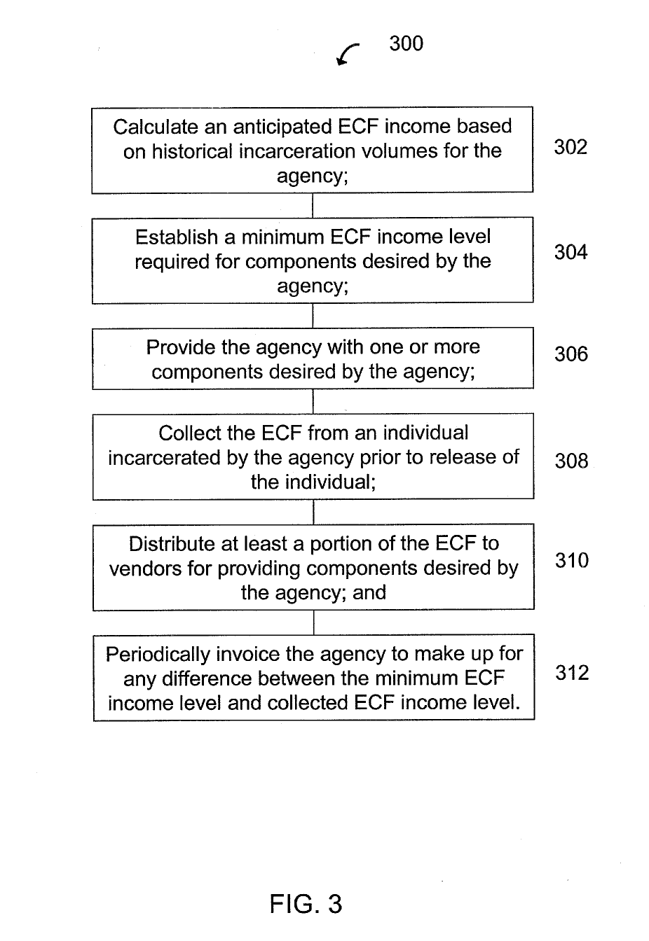

As shown in FIG. 3, a block diagram representation of an embodiment of the method 300 in accordance with another embodiment of the present invention. In block 302 an anticipated ECF income is calculated based on historical incarceration volumes for the agency. Communities in rural areas and agencies with fewer resources may also benefit from the enhanced system in accordance with the present inventive system and method. According to some embodiments of the present inventive method and system, calculation of the historical incarceration volumes for the agency may additionally include other metrics such as statewide, regional, or nationwide incarceration volumes, or some adjustment therefore. Depending on the specific needs of a particular agency, components of the enhanced system may be grouped and available for funding at a certain ECF income level.

In block 304, a minimum ECF income level is established as being required to supply components desired by the agency. One of skill in the art will appreciate that, in the case of some agencies, a threshold ECF funding level amount may be established for the addition of a set or group of system components. In block 306, the agency is provided with one or more components desired by the agency. In block 308, the ECF is collected from an individual incarcerated by the agency prior to release of the individual. In block 310, at least a portion of the ECF is distributed to consortium vendors for providing components desired by the agency.

In block 312, the agency is periodically invoiced the agency to make up for any difference between the minimum ECF income level and collected ECF income level. For agencies that lack the historical incarceration volumes to meet the ECF minimum income level for a component group, the agency would still be able to obtain a particular component group for a fee. According to some embodiments, such fee may be paid at the outset upon receipt of the components or deferred until the end of a period of time where such fee would be the difference between the threshold minimum group level and the actual ECF income received for the period.

One of ordinary skill in the art will appreciate that the processes of the present invention, as well as certain aspects thereof, are capable of being distributed in the form of a computer readable medium of instructions and a variety of forms and that the present invention applies equally regardless of the particular type of signal bearing media actually used to carry out the distribution.

It will be understood that certain features and subcombinations are of utility and may be employed without reference to other features and subcombinations. This is contemplated by and is within the scope of the claims. Since many possible embodiments may be made of the invention without departing from the scope thereof, it is to be understood that all matter herein set forth or shown in the accompanying drawings is to be interpreted as illustrative, and not in a limiting sense.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A method of enhancing the operation of law enforcement agency systems via self-funding, the method comprising the steps of:
providing an agency with one or more components desired by the agency;
collecting an electronic custodial fee (“ECF”) from an individual incarcerated by the agency; and
distributing at least a portion of the ECF to one or more vendors for providing the one or more components to the agency.

2. The method of claim 1 where the components comprise services.

3. The method of claim 1 where the components comprise a biometric identification system.

4. The method of claim 1 where the ECF fee is collected from the individual prior to release by the agency.

5. The method of claim 4 further comprising the step of periodically adjusting the amount of the ECF collected from the individual prior to release by the agency.

6. The method of claim 1 further comprising the steps of:
determining a historical incarceration volume for the agency;
calculating a projected ECF income level based on historical incarceration volumes for the agency; and
periodically adjusting the value of the ECF amount to at least meet the projected ECF income level.

7. The method of claim 6 where the step of determining a historical incarceration volume for the agency includes adjusting the historical incarceration volume by a factor based on regional and statewide incarceration volumes.

8. A method of enhancing the operation agency systems via an electronic custodial fee (“ECF”), the method comprising the steps of:
calculating an anticipated ECF income based on historical incarceration volumes for the agency;
establishing a minimum ECF income level required for components desired by the agency;
providing the agency with one or more components desired by the agency;
collecting the ECF from an individual incarcerated by the agency prior to release of the individual;
distributing at least a portion of the ECF to vendors for providing components desired by the agency; and
periodically invoicing the agency to make up for any difference between the minimum ECF income level and collected ECF income level.

9. The method of claim 8 where one or more of the components comprise services, equipment, or a combination thereof.

10. The method of claim 8 where one or more of the components comprise a biometric identification system.

11. The method of claim 8 where the step of calculating an anticipated ECF income based on historical incarceration volumes for the agency includes adjusting the anticipated ECF income by a factor based on regional and statewide incarceration volumes.

12. A system for enhancing the operation agency systems via an electronic custodial fee (“ECF”) including:
means for calculating an anticipated ECF income based on historical incarceration volumes for the agency;
means for establishing a minimum ECF income level required for components desired by the agency;
means for providing the agency with one or more components desired by the agency;
means for collecting the ECF from an individual incarcerated by the agency prior to release of the individual;
means for distributing at least a portion of the ECF to vendors for providing components desired by the agency; and
means for periodically invoicing the agency to make up for any difference between the minimum ECF income level and collected ECF income level.

13. A method of funding agency equipment at an agency, the method comprising:
determining an agency's equipment desires;
matching the agency's equipment desires with one or more third-party equipment vendors;
obtaining equipment provided by the one or more third-party equipment vendors at no cost to the agency;
installing equipment provided by the one or more third party equipment vendors at the agency;
charging a fee to a person incarcerated by the agency and/or processed by the agency utilizing the equipment; and
submitting at least a portion of the fee to the third-party provider to pay for at least a portion of the cost of the equipment.
